(19) United States
(12) Patent Application Publication
(10) Pub. No.: US 2009/0215361 A1
(43) Pub. Date: Aug. 27, 2009

(54) Method for near-net-shape machining of curved contours

(75) Inventor: Mark Geisel, Gauting (DE)

Correspondence Address: Davidson, Davidson & Kappel, LLC, 485 7th Avenue, 14th Floor, New York, NY, 10018, US

(73) Assignee: MTU Aero Engines GmbH, Muenchen (DE)

(21) Appl. No.: 12/380,146

(22) Filed: Feb. 24, 2009

(30) Foreign Application Priority Data
Feb. 25, 2008 (DE) DE 102008010982.7

(51) Int. Cl. B24B 49/04; G05B 19/404; G05B 19/4099

(52) U.S. Cl. 451/5; 451/48; 700/164; 700/181; 700/187

(57) ABSTRACT

A method relating to near-net-shape machining of curved contours such as those occurring, for example, in the fabrication of blades for propulsion engines and the like is described. Accordingly, the shape error in curve grinding is minimized by suitable compensation functions, in particular by interpolating and approximating cubic splines. The present method minimizes the number of tests required to set up a grinding machining operation and thus the number of semifinished products required to do so. At the same time, rejects in fabrication of curved workpieces are reduced by increasing the machining quality. The use of complex chucking devices is avoided and cutting performance is maximized.

Priority is claimed to German Patent Application DE 10 2008 010 982.7, filed Feb. 25, 2008, the entire disclosure of which is hereby incorporated by reference herein.

The present invention relates to the field of machining of workpieces, in particular by CNC machine tools, and here specifically by grinding machines. More specifically, it relates to a method for near-net-shape machining of curved contours, such as those which occur, for example, in the fabrication of blades for propulsion engines and the like.

### BACKGROUND OF THE INVENTION

Grinding, among other methods, is used for manufacturing precisely shaped surfaces. In contrast with methods using a geometrically specific cutting edge, grinding methods are classified as machining methods having a geometrically indeterminate cutting edge. Sharp-edged grains of a certain order of magnitude embedded in a binder are often used as the separating agent. By repeated movement of the grinding tool along the surface to be machined under pressure, the top layer of the surface to be machined is gradually worn away. The particles thereby released together with any grinding grains that might have been separated are conveyed by rotary movements, for example, toward the edges of the grinding tool so that they may then be removed by suction or rinsing at these edges. As an alternative to embedded abrasive agents, loose abrasive agents in liquid or paste form also may be placed between the workpiece and a grinding disk. Machining is performed similarly under pressure using repeating relative movements, e.g., rotary movements, between the tool and the workpiece. By introducing fresh abrasive agent, e.g., through a central borehole in the grinding tool, used abrasive agent and abrasive agent containing cut material are removed from the contact area of the tool.

Specifically for manufacturing curved contours such as turbine blades, for example, so-called “vane grinders” or “blade grinders” are used. Due to the complex geometries, control of such machine tools is not trivial, so corresponding programs (grinding operations, grinding cycles) are also needed and must be made available by the machine manufacturers or independent suppliers or must be programmed by the user himself. In the case of curved contours, such control programs are also known as curve grinding operations. The achievable quality depends on the precision of the machine tool as well as the quality of the control software.

One problem in manufacturing curved contours in particular is that there is often a substantial deviation between the desired setpoint contour and the actual contour achieved. One main reason for this deviation is that the grinding operations available commercially at the present time include only inadequate compensation for deformations or none at all. On the one hand, this is due to the forces acting on the workpiece and, on the other hand, also due to the thermal expansion of the workpiece. In the extreme case, temperatures in the range of the melting point of the particular material may occur during grinding, thereby resulting in substantial thermal expansion as well as a local reduction in strength, which further increases the deforming effect of the grinding forces.

Attempts are made today to create an at least largely constant temperature field merely by varying the coolant supply to thereby minimize the thermally induced deviations in shape. However, the possibilities for intervention that may be achieved here are extremely limited, accordingly resulting in unsatisfactory results.

Furthermore, an attempt may be made to reduce deformation of the workpiece during machining by blocking using a plurality of fixation points and a corresponding chucking device having a complex design. However, in this case increased mechanical stresses occur in the material, which is unable to expand freely despite the elevated temperature, so that this procedure may in turn result in problems such as damage to the material.

Finally, by reducing the metal removing rate and/or the cutting performance (lower contact pressure, lower rotational speed, smaller tool, lower cutting depth), it is possible to lower the temperature during machining, so that the problems resulting from thermal expansion are less apparent. However, one unwanted side effect here in particular is a correspondingly longer machining time.

To obtain satisfactory machining results, today corresponding preliminary tests are conducted, on the basis of which an incremental adjustment of the actual contour to the setpoint contour is performed. For these tests, a corresponding semifinished product is needed each time, and the analysis of each test is time-intensive because the complex contours must be measured each time and the paths to be traveled must be readjusted. This results in high costs in setting up a procedure accordingly as well as a long setup time. In the case of inadequate preliminary tests, as well as due to technical limitations, this results in an increased number of rejects. These disadvantages are serious in particular with complex components, where semifinished products are already being manufactured in cost-intensive procedures and/or when using expensive materials.

### SUMMARY OF THE INVENTION

The object of the present invention is therefore to provide a method for near-net-shape machining of curved contours with the aid of 2D or 3D curve grinding operations. By using this method, the number of tests required to set up a grinding machining operation and therefore the number of semifinished products required for it are to be minimized. At the same time, rejects in fabrication of curved workpieces in particular are to be reduced by increasing the machining quality. Use of complex chucking devices should be avoided and the cutting performance should be maximized.

This object is achieved by a method for near-net-shape 2D and 3D machining of curved contours, characterized in that a compensated path movement (S) of a tool of a CNC machine tool has deviations (Δx) from a setpoint contour (K), so that shape errors are compensated during machining. Accordingly, a compensated path movement of a tool of a CNC machine tool is programmed in deviation from a setpoint contour, so that the machining result after the end of the procedure reflects the setpoint contour in first approximation. To do so, suitable compensation functions, in particular interpolating and approximating cubic splines, are used, so that minimization of the shape error in grinding curves may be achieved.

The method according to the present invention offers an increased shape precision in performing this method in both 2D and 3D curve grinding operations as well as in similar grinding operations.

This method thus is used for near-net-shape 2D and 3D machining of curved contours and is characterized in that path movement S of a CNC machine tool is programmed in deviation from a setpoint contour K so that the machining result reflects in first approximation setpoint contour K after the end of the procedure.

The curved contours may be, for example, the contours of blades for propulsion engines which are characterized in particular by a very high shape precision and/or minor deviations from a precisely defined setpoint shape. The method according to the present invention is also suitable for use in a wide variety of machine tools using CNC control (CNC=computer numerical controlled; computer controlled), but in particular in grinding machines for manufacturing curved 2D or 3D contours. The method according to the present invention is used to program a path movement deviating from a setpoint contour K, resulting in the fact that, when using precisely this path movement, the shape deviations that would otherwise occur when using programming of the unchanged setpoint contour are virtually eliminated. In other words, the machining result after the end of the procedure reflects setpoint contour K in first approximation.

According to a first preferred embodiment of the method according to the present invention, required deviations Δx of the movement sequence from setpoint contour K are ascertained by taking into account the force field and/or temperature field in effect during machining. Numeric and/or analytical methods may be used for this purpose. Use of simulation models in which the geometric data as well as the physical behavior of the workpiece during machining are stored as a function of relevant parameters such as temperature, pressure, material, etc., is preferred in particular. In addition to optimization of the path movement, such models also allow a check of analytically ascertained path movements, for example, without requiring tedious and expensive real tests to do so.

According to a second preferred embodiment of the method according to the present invention, required deviations S in the movement sequence from contour K are ascertained by testing. To do so, thus at least one real test is necessary in which an attempt is first made to fabricate the workpiece using a path movement corresponding to the setpoint contour. Resulting deviations Δx may then be determined by the measurement technology. This determination may be performed quasicontinuously (e.g., by sensing cutting methods) or discretely (e.g., by measuring calipers), but the latter variant is preferred because the volume of data to be recorded there is smaller, which may yield a substantial time advantage under some circumstances. Scanning of surfaces having a complex curvature, e.g., those with undercuts, may also be performed only in a very time-consuming method that involves a high complexity in terms of measurement technology. In the case of individual discrete measured points, however, it is important to be sure that the surface to be described may also be represented with sufficient accuracy by the measured points.

For the latter preferred embodiment (testing), the following formula mechanism may be formulated. The following equation thus holds for path movement S to be programmed at point in time t:

S(t)=K(t)+f(t)*(−Δx)
where S(t)=path movement at point in time t
K(t)=setpoint contour at point in time t
Δx=measured deviation after the end of testing
f(t)=correction function, where f(t)≧0 at point in time t.

The path movement at point in time t thus corresponds to the path the tool must follow to compensate for shape and/or measured deviations Δx and thereby yield a net-shape machining result that approaches the contour. Setpoint contour K(t) is defined by the construction. The correction function may optionally have to be determined by another means elsewhere, if necessary, or may first have to be assumed to be a constant.

For both embodiments of the method according to the present invention mentioned above, it is preferable in particular for the path movements S that are to be programmed to be interpolated or approximated by a function S′. This approximation is useful in the testing embodiment, however, because under some circumstances there, initially only a small number of measured points (interpolation points) is available, but path deviation S(t) to be programmed must be available quasicontinuously to allow a suitably accurate tracing of the total contour even between the measured points. Owing to the preference for the recording of just a small number of measured points which are available as interpolation points for such functions S′ that are to be interpolated or approximated, such that interpolating or approximating functions S′ are characterized by a very small number of free parameters, e.g., interpolation points are preferred in particular for the approximation of path movements S to be programmed.

Therefore, for interpolation or approximation of path movements S to be programmed, interpolating or approximating spline functions S′ are preferably used in particular, such as B splines or most preferably cubic splines. Alternatively, however, high-degree polynomials, piece-by-piece interpolations, etc., may also be used.

According to a preferred embodiment of the method according to the present invention, at least one of the steps described above of measurement of measured deviation Δx, calculation of path movement S and the interpolating or approximating function S′ proceeds as an automated operation. The calculations may preferably be performed using a commercial PC in particular. For detection of measured deviation Δx, an automatic or semiautomatic method may also be used, utilizing a corresponding device. If necessary, the corresponding measured points may first have to be preselected manually but they may also be selected by automated analysis and planning software, which enters the setpoint contour and from which the optimum position of measured points is determined. The approach and measurement at these interpolation points are then preferably performed automatically again. According to an embodiment that is preferred in particular, all the steps described in the previous paragraph take place automatically. This yields the shortest possible through-time from the first measurement until the determination of the interpolating or approximating function S′. Furthermore, the result is reproducible inasmuch as the influence of possibly different operators is largely ruled out.

By using the method according to the present invention, the number of tests required to set up a grinding machining operation and therefore the number of semifinished products required for this are minimized because only a single test is necessary to ascertain the measured deviation by testing in the optimum case. At the same time, by increasing the machining quality, rejects in fabrication of curved workpieces are reduced. Use of complex chucking devices is avoided because the shape deviations that result when using simpler chucking devices are compensated. Likewise the shape deviations observed by increased machining temperatures are compensated so that the cutting performance is maximized inasmuch as a reduction in the load on the workpiece during machining, e.g., by having a lower metal removal rate, is not necessary.

### BRIEF DESCRIPTION OF THE DRAWINGS

The present invention is described below by reference to the following drawings, in which:

FIG. 1 shows a flow chart of the two variants of the method according to the present invention; and

FIG. 2 shows as an example and in simplified form the exemplary curve of a setpoint contour, an actual contour and a path movement.

### DETAILED DESCRIPTION

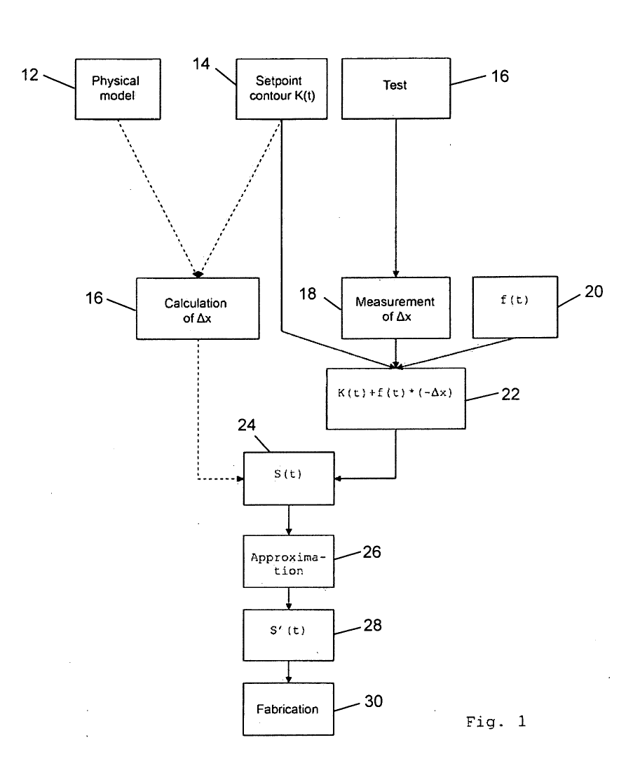

FIG. 1 shows a flow chart of the two variants of the method according to the present invention.

In the left half of the figure, the “analytical” or “numerical” variant of the method according to the present invention is shown. Components of the diagram corresponding to this variant are indicated by dashed connecting lines.

Thus, in a step 12 a setpoint contour K(t) which corresponds to the desired workpiece shape after machining is predefined. Furthermore, in a step 10, the physical behavior of the workpiece during machining is stored in the form of a suitable model.

With the help of analytical or numerical methods, in a step 16, a calculation of an expected measured deviation Δx will now be performed.

The difference between deviation Δx and setpoint correction K(t) corresponds essentially to path movement S(t) actually to be programmed. The path movement S(t) to be programmed is determined in a step 24 based the difference between deviation Δx and setpoint correction K(t).

The function thereby found is approximated by an interpolating or approximating spline function S′(t) which is provided according to the present invention (26, 28).

During a fabrication step 30 net-shape fabrication of the workpiece, the tool then follows the path predefined by spline function S′(t).

The right half of the figure shows the “testing” variant of the method according to the present invention. The components of the diagram corresponding to this variant are characterized by solid connecting lines.

Accordingly, a setpoint contour K(t) is also given here in step 12.

Using the path data of this setpoint contour, one or more tests are conducted in a step 14.

Measured deviation Δx from setpoint contour K(t) may be determined from these tests in a step 18. As few discrete measured points as possible are preferably approached here but they are nevertheless sufficient to approximate the actual contour with a sufficiently good agreement.

In addition, a correction function f(t), 20, should also be known for which f(t)≧0 holds at any time. Function f(t) may also be constant, however.

By linking setpoint contour K(t) to correction function f(t) and measured deviation Δx, path movement S(t) that is to be programmed may be deduced (22, 24). However, this function may be determined only for discrete measured values Δx recorded previously. An approximation of the interpolation points by an interpolating or approximating spline function S′(t) provided according to the present invention is now performed—as in the variant described above—to be able to provide path information for the locations on the contour (26, 28).

During net-shape fabrication of the workpiece in step 30, the workpiece then follows the path predefined by spline function S′(t).

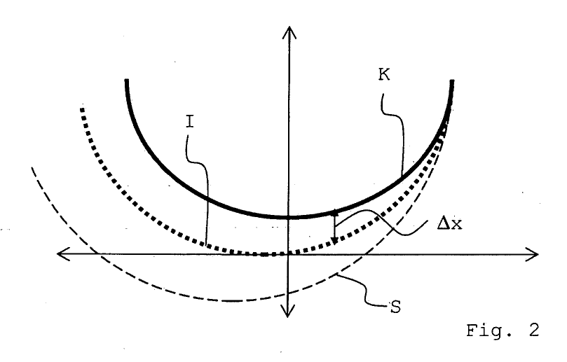

FIG. 2 shows as an example in simplified form the exemplary curve of a setpoint contour K, an actual contour I and a path movement S.

The contours are entered into a coordinate axis, which is symbolized by the perpendicular thin lines.

Setpoint contour K is a semicircle symmetrical with the Y axis, represented as a bold semicircular line in FIG. 2. In contrast with that, actual contour I resulting from a first nonoptimized machining is discernible as a bold dotted line which clearly deviates from setpoint contour K. In the example shown here, the radius of actual contour I is much greater than the radius of setpoint contour K. Between the two contours there is thus a measurement distance Δx, which is given here as an example of a single location and/or fabrication point in time t.

By using the method according to the present invention, a path movement S (thin dashed line) may now be determined, yielding the desired net-shape fabrication of the workpiece when used as the setpoint contour for controlling the tool. In the simplest case, this path movement is obtained by subtracting measured deviation Δx from setpoint contour K, if necessary, with the assistance of a correction function f(t) (not shown here).

### LIST OF REFERENCE NUMERALS AND ABBREVIATIONS

I actual contour
K setpoint contour
f correction function
Δx deviation in movement sequence
t point in time
S path movement
S′ interpolating or approximating function

What is claimed is:

1. A method for machining a curved contour comprising the steps of:
determining a deviation from a setpoint contour, the setpoint contour corresponding to a desired shape of a workpiece;
determining a compensated path movement of a tool of a CNC machine tool based on the deviation; and
machining the workpiece based on the compensated path movement to compensate shape errors.

2. The method as recited in claim 1, wherein the deviations from the setpoint contour are ascertained by taking into account the force field in effect during machining.

3. The method as recited in claim 1, wherein the deviations from the setpoint contour are ascertained by taking into account the temperature field in effect during machining.

4. The method as recited in claim 1, wherein the deviations from the setpoint contour are ascertained analytically.

5. The method as recited in claim 1, wherein the deviations from the setpoint contour are ascertained numerically.

6. The method as recited in claim 1, wherein the deviations from the setpoint contour are ascertained empirically and then stored in a table.

7. The method as recited in claim 6, wherein the compensated path movement is calculated according to the following equation:
S(t)=K(t)+f(t)*(−Δx)
where S(t)=path movement at point in time t
K(t)=setpoint contour at point in time t
Δx=deviations from the setpoint contour
f(t)=correction function, where f(t)≧0 at point in time t.

8. The method as recited in claim 1, wherein interpolating or approximating functions are used for determining the compensated path movement.

9. The method as recited in claim 8, wherein the interpolating or approximating functions are characterized by a few free parameters.

10. The method as recited in claim 9, wherein the interpolating or approximating functions are spline functions.

11. The method as recited in claim 1, wherein the step of determining the deviation from the setpoint contour proceeds as an automated operation.

12. The method as recited in claim 1, wherein the step of determining the compensated path movement proceeds as an automated operation.

13. The method as recited in claim 1, wherein the step of machining the workpiece proceeds as an automated operation.

14. A computer program product, comprising a computer usable medium having a computer readable program code embodied therein, the computer readable program code adapted to be executed to implement a method of machining a curved contour, the method comprising the step of:
determining a deviation from a setpoint contour, the setpoint contour corresponding to a desired shape of a workpiece;
determining a compensated path movement of a tool of a CNC machine tool based on the deviation; and
machining the workpiece based on the compensated path movement to compensate shape errors.

15. A data medium comprising a computer program as recited in claim 14.
